(19) United States
(12) Patent Application Publication
(10) Pub. No.: US 2007/0199353 A1
(43) Pub. Date: Aug. 30, 2007

(54) Steam generator and drum type washing machine with the same

(75) Inventors: Ki Chul Woo, Seoul (KR); Si Moon Jeon, Seoul (KR); Kyung Chul Woo, Seoul (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/709,875

(22) Filed: Feb. 23, 2007

(30) Foreign Application Priority Data
Feb. 24, 2006 (KR) 10-2006-0018209

(51) Int. Cl. B08B 3/12; D06F 37/00; D06F 23/00

(52) U.S. Cl. 68/5 R; 68/3 R; 68/140

(57) ABSTRACT

The present invention relates to a steam generator. More particularly, the present invention relates to a steam generator which has a compact design to enhance efficiency, and to a drum-type washing machine with this steam generator. The steam generator includes a heater that heats water to generate steam; a lower case that holds water for steam generation, having a heater holding part in which the heater is vertically oriented in the heater holding part, and an upper case coupled to an upper portion of the lower case to form a predetermined space.

This application claims the benefit of the Korean Patent Application No. 10-2006-0018209, filed on Feb. 24, 2006, which is hereby incorporated by reference as if fully set forth herein.

### BACKGROUND OF THE DISCLOSURE

1. Field of the Disclosure

The present invention relates to a steam generator. More particularly, the present invention relates to a steam generator in a home appliance having a compact design to enhance efficiency.

2. Discussion of the Related Art

Generally, washing machines and dryers are home appliances that are used to clean laundry by washing and drying the laundry. Alternatively, it is known for a single appliance to perform both washing and drying functions.

In general, washing machines are categorized based on the method used to perform washing, for example, a pulsator-type washing machine and a drum-type washing machine. A pulsator-type washing machine includes a plate-shaped pulsator that is rotated to generate water currents to perform washing. A drum-type washing machine performs ashing by rotating a horizontally oriented drum to produce a frictional force between the wash water and the laundry. Additionally, in a drum-type washing machine, as the drum is rotated, wash water and laundry adhere to the surface drum by centrifugal force and when the drum reaches a predetermined position, the wash water and laundry fall from the inner surface of the drum providing additional agitation to clean the laundry.

Of the two types, the drum-type washing machine has become more desirable because it consumes less wash water and less detergent while reducing damage to the laundry fabrics.

Recently, a steam generator has been included in a drum-type washing machine that includes a drying function. The steam generator generates and supplies hot steam to the laundry during a washing process to enhance washing efficiency. Steam may also be supplied to the laundry during a drying cycle to eliminate any wrinkles remaining in the laundry.

A conventional steam generator for a washing machine is described as follows.

As shown in FIG. 1, a drum-type washing machine having a conventional steam generator includes a cabinet 10, a cylindrical tub 12, a drum 14 and a steam generator 16. The cabinet 10 defines an exterior of the drum-type washing machine and the tub 12 is horizontally mounted within the cabinet 10 to hold wash water. The drum 14 is rotatably mounted within the tub 12 and the steam generator 16 supplies steam into the drum 14.

An opening 18 is formed in a front surface of the cabinet 10 through which laundry is loaded and unload from the drum 14. A door 20 is coupled the opening 18 and rotates to open and close the opening 18.

A water supply valve 22 and a water supply hose 24 are provided in a side of the cabinet 10 to supply water to the steam generator 16 and the tub 12.

Also, the steam generator includes a steam supply tube 26 to guide the steam generated in the steam generator 16 into the drum 14. In reference to FIGS. 2 and 3, the conventional steam generator 16 will now be described in detail.

The steam generator 16 includes a lower case 28 forming space to hold water, an upper case 30 coupled to the lower case 28 and a heater 32 for heating the water stored in the steam generator 16.

A water inlet 34 and a steam outlet 36 are formed in the upper case 30. Water supplied to the steam generator 16 passes through a water inlet 34 and after the heater 32 heats the water and steam is produced, the steam passes through the steam outlet 36 into the system supply tube 26.

As shown in FIG. 3, the heater 32 is installed on a bottom surface of the lower case 28 such that the heater 32 is positioned parallel to the bottom surface. When water is supplied to the steam generator 16, the heater 32 is completely submerged in the water. Power is supplied to the heater 32 via a terminal.

A bracket 33 is provided on the bottom surface of the lower case 28 and the heater 32 is inserted in the bracket 33. One side of the heater 32 is fixed in the bracket 33 and other of the heater 32 is fixed to a side surface of the lower case 28.

A water level sensor 40 is provided in the upper case 28 to sense a water level of the water stored within the steam generator 16. A temperature sensor 42 is provided in the upper case 28 to sense the temperature inside the case 28 and 30 produced by the water and steam heated by the heater 32.

Due to the size and orientation of the heater 32, the conventional steam generator described above exceeds the capacity necessary to adequately supply steam to the drum 14. Since the steam generator exceeds the necessary capacity, the power usage of the washing machine increases and efficiency of the drum-type washing machine deteriorates. In addition, the size of the cabinet increases in order to accommodate the steam generator 16. Thus, the manufacturing costs increase due to the additional materials and the necessary changes to the cabinet.

Furthermore, due to the orientation of the heater, water heated by the heater splashes within the steam generator and is supplied to the drum 14 in addition to the steam. Thus, the hot water damages fabrics of the laundry.

Also, as the water is heated to produce steam, the water boils, generating bubbles within the water. The bubbles produced adversely effect the water level sensor 40 and cause the sensor to malfunction.

Finally, the bracket 33 provided on the bottom surface of the lower case 28 is highly susceptible to mineral deposits and foreign substances adhering to the surfaces of the bracket 33. Thus, power consumption of heater of the steam generator 16 increases and efficiency deteriorates. Also, according to the conventional steam generator 16, the heater 32 is completely inserted and fixed in the bracket 33. Thus, due to the large size of the bracket 33, production cost of the bracket increases.

### SUMMARY OF THE INVENTION

Accordingly, the present invention is directed to a steam generator and a drum-type washing machine with the same.

An advantage of the present invention is to provide a steam generator, for use in various products, that enhances steam generation efficiency with a compact design.

Another advantage of the present invention is to provide a steam generator that prevents high temperature water from being introduced into a drum and prevents a water level sensor malfunction.

A further advantage of the present invention is to provide a steam generator in a drum-type washing machine to enhance washing efficiency. Thus, an overall size of the drum-type washing machine is reduced.

Additional features and advantages of the invention will be set forth in part in the description which follows, and in part will become apparent from the description or may be learned from practice of the invention. The objectives and other advantages of the invention will be realized and attained by the structure particularly pointed out in the written description and claims hereof as well as the appended drawings.

To achieve these objects and other advantages and in accordance with the purpose of the invention, as embodied and broadly described herein, a steam generator includes: a heater that heats water to generate steam; and a case that holds the water for steam generation, wherein the heater may be vertically oriented within the case.

In another aspect of the present invention, a steam generator includes: a case that forms a predetermined space; a heater holding part formed in a recessed portion of a lower surface of the case; a heater installed within the recessed portion; and a guide part that guides the water supplied to the steam generator into the recessed portion, such that the water fills up the recessed portion first.

In a further aspect of the present invention, a drum-type washing machine includes: a cabinet that defines an exterior of the drum-type washing machine; a tub provided within the cabinet to store wash water; a drum rotatable within the tub, wherein laundry is introduced into the drum; and a steam generator that supplies steam into the tub or the drum; wherein the steam generator comprises, a heater holding part formed in a recessed portion of a case, wherein water collects in the heater holding part and a heater having at least some portion disposed within the heater holding part.

It is to be understood that both the foregoing general description and the following detailed description are exemplary and explanatory and should not be construed as limiting the scope of the claims.

### BRIEF DESCRIPTION OF THE DRAWINGS

The accompanying drawings, which are included to provide a further understanding of the invention and are incorporated in and constitute a part of this specification, illustrate embodiments of the disclosure and together with the description serve to explain the principle of the invention.

In the drawings:

FIG. 1 is a perspective view schematically illustrating a conventional drum-type washing machine;

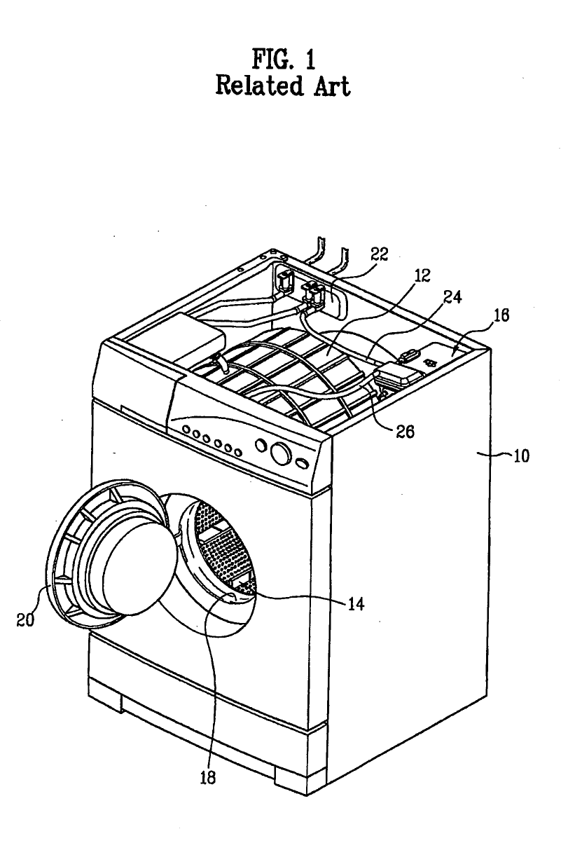

FIG. 2 is a perspective view schematically illustrating a conventional steam generator;

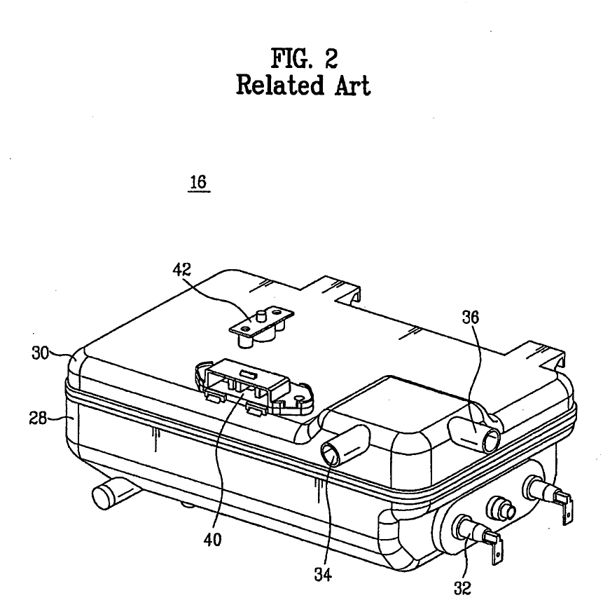

FIG. 3 is a cut-away perspective view illustrating the steam generator of FIG. 2, seen at a different angle;

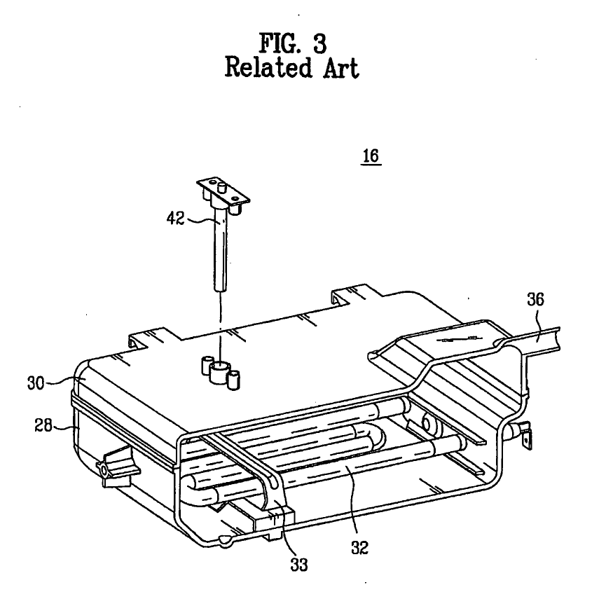

FIG. 4 is a perspective view of a steam generator according to the present invention;

FIG. 5 is a diagram illustrating an upper case of the steam generator according to the present invention, seen from below;

FIG. 6 is a longitudinally sectional view of the steam generator according to the present invention, seen from the rear;

FIG. 7 is a perspective view schematically illustrating a heater fastening part of the steam generator according to the present invention; and

FIG. 8 is a perspective view illustrating a drum-type washing machine to which the steam generator according to the present invention is adapted.

### DESCRIPTION OF THE ILLUSTRATED EMBODIMENTS

Reference will now be made in detail to embodiments of the present invention, examples of which are illustrated in the accompanying drawings. Wherever possible, the same reference numbers will be used throughout the drawings to refer to the same or like parts.

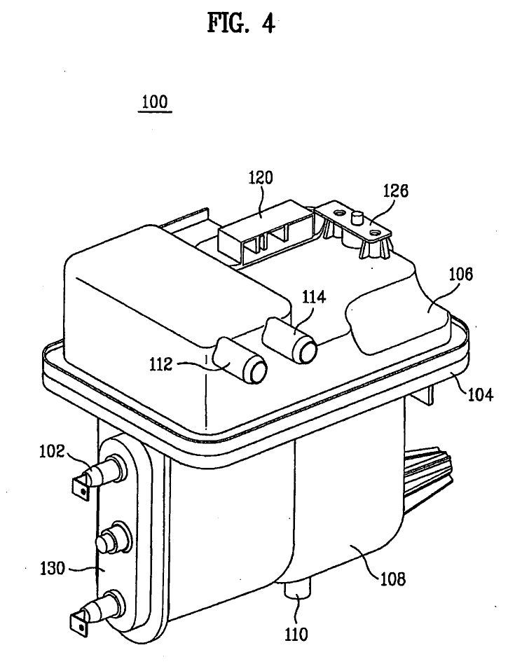

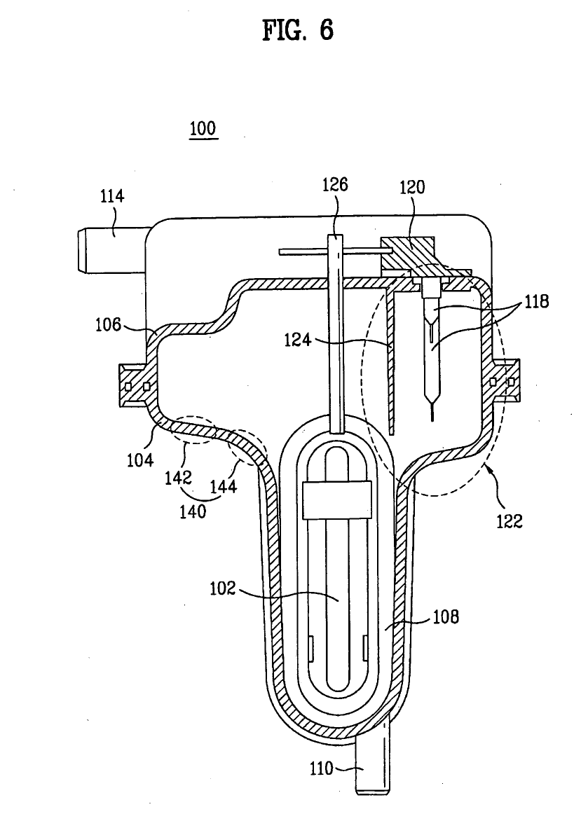

In reference to FIGS. 4 to 6, a steam generator 100 for a laundry device according to an embodiment of the present invention includes a heater 102 and a case. The case is formed of a lower case 104 and an upper case 106 where the lower case 104 and the upper case 106 are coupled to each other to form a predetermined space for generating steam. The upper and lower case 106 and 104 may be a pressure container for generating and supplying high pressure, high temperature steam into the drum. In the lower case 104, a recess 108 is formed and at least a portion the heater 102 is positioned vertically within the recess 108.

The heater 102 heats water stored within the steam generator 100 to generate steam. Various heaters may be used within the steam generator, including for example a sheath heater. A sheath heater may be desirable because it has high heat efficiency and the ability heat water quickly.

In contrast to the conventional steam generator, the heater 102 according to the present invention is installed vertically within the lower case 104 such that the majority of the surface area of the heater 102 is substantially perpendicular to the bottom surface of the lower case 104. In other words, the majority of the heater 102 surface area is adjacent to the sides of the recessed part 108.

Inner side surfaces of the recess 108 in the lower case 104 are spaced apart at a predetermined distance from the heater 102 to minimize the amount of water necessary to submerge the heater 102. The recess 108 may be formed in the center of the lower case 104 in order to allow the water to be heated uniformly within the steam generator 100.

A guide part 140 is further provided in the lower case 104 to guide the water introduced into the steam generator 100 into the recess 108 such that the recess 108 fills with water prior to any other component of the steam generator 100. The guide part 140 includes an oblique part 142 and a curved part 144. The oblique part 142 is inclined toward the recess 108 and the curved part 144 is curved to smoothly connect the oblique part 142 with the recess 108. After the recess 108 is completely filled with water, the water may also fill into the remaining portion of the lower case 104.

A water drain hole 110 is provided on the bottom surface of the recess 108 in the lower case 104. When supplying steam to the drum is complete or the washing machine is in repair, any water remaining in the steam generator 100 may be discharged through the water drain hole 110.

The upper case 106 includes a water inlet 112 and a steam outlet 114. Water supplied to the steam generator 100 passes through the water inlet 122 and steam is discharged through the steam outlet 114 into the drum.

A water splash prevention partition structure 116 is formed on an inner wall of the upper case 106, adjacent to the steam outlet 114. The water splash prevention partition structure 116 prevents the heated water from passing through the steam outlet 114 into the drum.

The water splash prevention partition structure 116 may extend downward from an inner upper surface of the upper case 106. The water splash prevention partition structure 116 may also extended into the lower case 104.

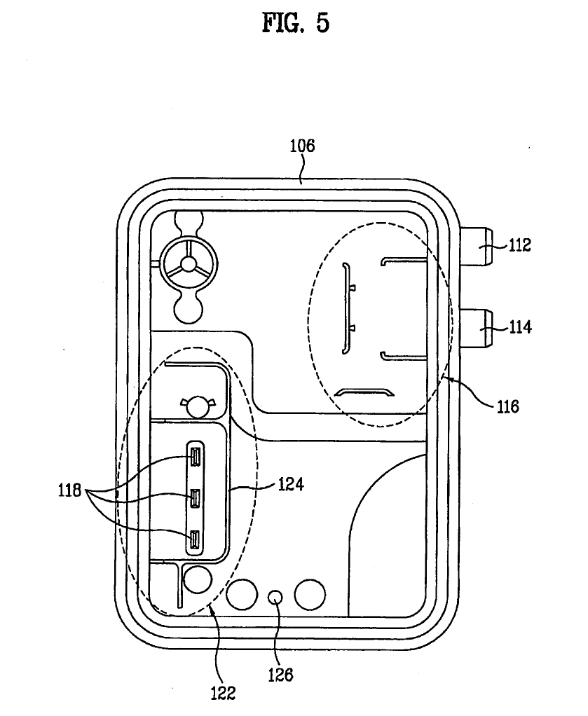

As shown in FIG. 5, a plurality of walls may comprise the water splash prevention structure 116. The water splash prevention partition structure 116 may be provided to surround the steam outlet 114. A path is formed between two adjacent water splash prevention partition structure 116 walls so that the steam passes through the path and may be discharged easily from the steam generator 100.

Each end of the walls of a water splash prevention partition structure 116 may be formed in a streamline shape, as shown in FIG. 5.

A water level sensor 120, including at least one electrode 1118, is provided in a predetermined portion of the upper case 106 to sense a level of the water. When the electrode 118 is submerged in the water stored in the steam generator 100, electric currents flow through the water to sense the water level. The water level sensor may send a signal indicative of the water level to a microprocessor.

As the heater 102 heats the water to generate steam, the water reaches boiling temperatures and bubbles are generated in the heated water. The bubbles cause the heated plash within the case. Due to the bubbles and the splashing water, the water level sensor 120 may malfunction. In order to prevent malfunction, a partition wall chamber 122 is formed in the upper case 106 and the partition wall chamber surrounds the electrode 118.

A water level sensor protection partition wall 124 may be included in the partition wall chamber 122 and may extend downward from an inner upper surface of the upper case 106.

Since it may be desired for water to be introduced into the partition wall chamber 122, the lower portion of the partition wall chamber 122 may be opened. A hole (not shown) may also be formed on an upper portion of the partition wall chamber 122, allowing water to more easily fill within the partition wall chamber 122.

The water level sensor 120 may be installed in various positions on the steam generator 100 including, a side portion of the upper case 106. In addition, the water level sensor 120 may be installed in a portion of the upper case 106 which corresponds to a portion of the lower case 104 which is not recessed.

A minimum water level required to submerge the heater 102 should be maintained so as to prevent heater 102 from overheating. The minimum water level may be higher than the water level within the recess 108.

The distance between an end of the water level sensor 120 and a bottom surface of the lower case 104 may be relatively small in the steam generator 100. Thus, any bubbles generated from the heated water may be reduced and any malfunction of the water level sensor 120 may be prevented.

A temperature sensor 126 may be installed in the upper case 106. The temperature sensor 126 periodically senses the internal temperature of the case. If the internal temperature exceeds a predetermined temperature, the heater 102 is turned off to prevent the heater 102 from overheating.

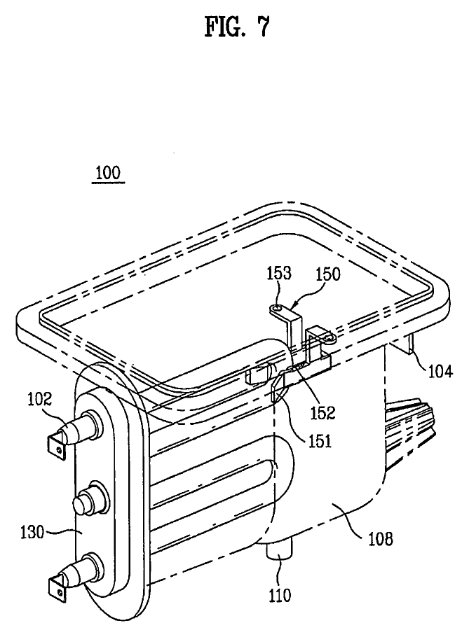

Next, in reference to FIG. 7, a securing structure of the heater 102 will be described.

The heater 102 may pass through a wall of the recessed portion 108 of the lower case to be secured within the steam generator. The portion of the lower case 104 which the heater 102 passes through may be tightly sealed in various ways. Also, at least one end of the heater 102 may be supported within in the sealed portion 130.

The other end of the heater 102 inserted into the steam generator 100 may be fixed by a heater securing part. The heater securing part may be a bracket 150.

The bracket 150 secures the heater 102 to the lower case 104. The bracket 150 may include a holding part 152 in which the heater 102 is fixedly held and a fixing part 153 by which the bracket 150 is fixed within the steam generator 100. In contrast to the conventional bracket provided in the conventional steam generator, the heater securing part 150 significantly reduces the amount of space required to secure the heater within the case and does not impede the flow of water and steam within the steam generator 100.

The holding part 152 may have guide parts 151 formed on both opposite ends thereof to ensure that the heater 102 is inserted precisely into the bracket. For example, the guide parts 151 may be positioned wider than the holding part 152. As the heater 102 is inserted, the guide parts 151 guide the heater into the holding part 152 to be fixedly secured. The fixing part 153 of the bracket 150 may be fixed to an inner surface of the lower case 104, the inner surface facing the wall of the lower case which the heater 102 passes through. Alternatively, the fixing part 153 may be fixed to an inner wall of the upper case 106. As shown in FIG. 7, the fixing part 153 of the bracket 150 may be fixed by a bolt fastening hole or the like.

The position of heater securing part 150 significantly reduces the mineral deposits and foreign substances from adhering to the heater securing part 150, thereby improving heater efficiency by preventing premature deterioration the heater.

A drum-type washing machine 128 including a steam generator 100 according to an embodiment of the present invention will be described.

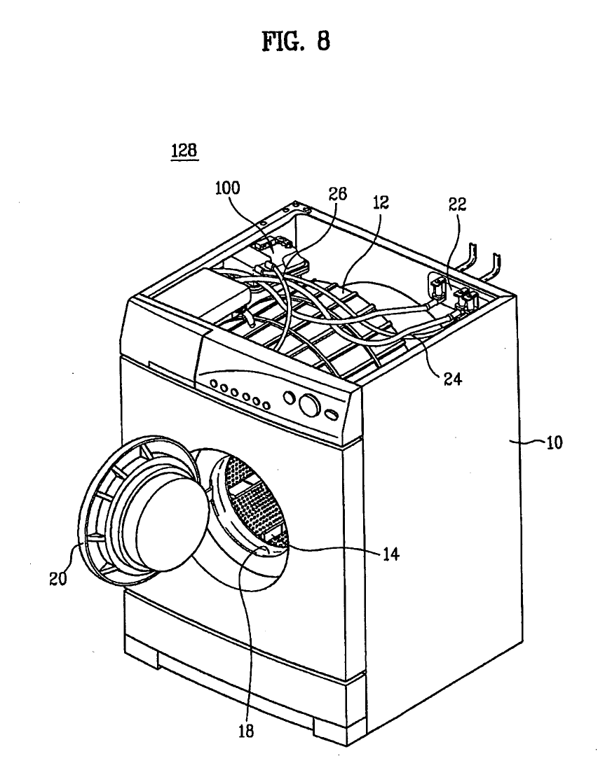

In reference to FIG. 8, the drum-type washing machine 128 having the steam generator 100 according to the present invention includes a cabinet 10, a tub 12, a drum 14 and the steam generator 100. The cabinet 10 defines an exterior of the drum-type washing machine. Washing water is stored in the tub 12, provided within the cabinet 10. Laundry is introduced into the drum 14. Drum 14 is rotatable within the tub 12. The steam generator 100 supplies steam to the tub 12 or the drum 14.

An opening 18 formed in the front of the cabinet 10 allows laundry to be loaded and unloaded into the drum 14. A door 20 is coupled to the opening 18 to open and close the opening 18.

A water supply valve 22 is provided in the cabinet 10 to supply water to the steam generator 100 and the tub 12. A water supply hose 24 connects the water supply valve 22 to the water inlet 112 of the steam generator 100.

The steam supply tube 26 is connected to the steam generator 100 to inject steam generated in the steam generator 100 into the tub 12 or drum 14. The steam supply tube 26 is connected to the steam outlet 114 of the steam generator 100.

According to an embodiment of the present invention, the length of the water supply hose 24 and the steam supply tube 26 may be reduced. Also, the water supply hose 24 and the steam supply tube 26 may be provided in an upper portion of the cabinet 10.

The steam generator 100 having the above heater arrangement may have a reduction of 30-40% in length in comparison to the conventional steam generator. While the steam generator 100 may be more compact in design, the steam generator 100 according to an embodiment of the present invention may have the same heating capacity and an improved heating efficiency in comparison to the conventional steam generator.

When the steam generator 100 is installed in the drum-type washing machine, the overall exterior size of the cabinet for the drum-type washing machine can be reduced.

An operation of the steam generator 100 adapted to a drum-type washing machine 128 will now be described.

Once a washing cycle of the drum-type washing machine 128 is selected, the washing cycle starts and water is supplied to the steam generator 100 via the water inlet 112 connected to the water supply hose 24. After the water reaches predetermined water level, the heater 102 provided in the recess 108 heats the water and steam is generated. The steam is discharged from the steam generator 100 via the steam outlet 114 and the steam is injected into the drum 14 via the steam supply tub 26.

In order to protect the heater, the water level in the steam generator 100 is kept at a level high enough to at least fully submerge the heater. The water level sensor 120 monitors the level of the water in the steam generator. If the water level drops below a predetermined water level, water is re-supplied to the steam generator 100.

Once a steam supply cycle is finished, the power supplied to the heater 102 is cut off and the remainder of any selected washing cycles are performed. Any water remaining within the steam generator 100 may be drained through the water drain hole 110.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

For example, the steam generator 100 may be incorporated into various appliances in addition to a drum-type washing machine.

What is claimed is:

1. A steam generator comprising:
a heater that heats water to generate steam; and
a case that holds the water for steam generation, wherein the heater is vertically oriented within the case.

2. The steam generator of claim 1, wherein the case comprises: a lower case and an upper case coupled to an upper portion of the lower case to form a predetermined space, wherein a portion of the lower case is recessed and the heater is positioned within the recessed portion of the lower case.

3. The steam generator of claim 2, wherein the recessed portion is formed in a center of the lower case.

4. The steam generator of claim 2, wherein the heater is inserted in the recessed portion of the lower case through a side surface of the lower case.

5. The steam generator of claim 4, wherein an end of the heater is fixedly inserted in a heater securing part provided within the steam generator.

6. The steam generator of claim 5, wherein the heater securing part is a bracket fixed to an inner surface of the case.

7. The steam generator of claim 6, wherein the bracket comprises a holding part in which an end of the heater is fixedly inserted and a fixing part by which the bracket is fixed.

8. The steam generator of claim 7, wherein the holding part comprises a guide part that guides the end of the heater inserted in the holding part.

9. The steam generator of claim 4, wherein a steam outlet is provided in a side of the upper case to discharge steam though and at least one water splash prevention partition wall formed on an inner wall of the upper case, adjacent to the steam outlet, to prevent the water from passing through the steam outlet.

10. The steam generator of claim 9, wherein the water splash prevention partition wall is downwardly extended from an inner upper surface of the upper case.

11. The steam generator of claim 10, wherein an adjacent pair of water splash prevention partition walls forms a path to allow the steam to pass through.

12. The steam generator of claim 10, wherein each end of the water splash prevention partition wall is formed in a streamline shape.

13. The steam generator of claim 4, wherein a water level sensor having at least on electrode is provided in the upper case to sense a water level and a partition wall chamber is provided on an inner surface of the upper case to surround the water level sensor, a lower portion of the partition wall chamber being opened to allow water into the partition wall chamber.

14. The steam generator of claim 13, wherein a hole is formed in an upper portion of the partition wall chamber to allow air to flow through into and out of the partition wall chamber.

15. A steam generator comprising:
a case that forms a predetermined space;
a heater holding part formed in a recessed portion of a lower surface of the case;
a heater installed within the recessed portion; and
a guide part that guides the water supplied to the steam generator into the recessed portion, such that the water fills up the recessed portion first.

16. The steam generator of claim 15, wherein the guide part comprises an oblique part inclined toward the heater holding part and a curved part curved to connect the oblique part with the recessed portion.

17. A drum-type washing machine comprising:
a cabinet that defines an exterior of the drum-type washing machine;
a tub provided within the cabinet to store wash water;
a drum rotatable within the tub, wherein laundry is introduced into the drum; and
a steam generator that supplies steam into the tub or the drum;
wherein the steam generator comprises,
a heater holding part formed in a recessed portion of a case, wherein water collects in the heater holding part and
a heater having at least some portion disposed within the heater holding part.

18. The drum-type washing machine of claim 17, wherein the steam generator further comprises a heater securing part provided within the steam generator to fixedly secure an end of the heater.

19. The drum-type washing machine of claim 18, wherein the heater securing part is a bracket fixed to an inner surface of the case.

20. The drum-type washing machine of claim 17, wherein a steam outlet is provided in a side of the case and at least one water splash prevention partition wall is provided on an inner wall of the case to prevent the water from passing through the steam outlet, the water splash prevention partition wall being adjacent to the steam outlet.
